(19) United States
(12) Patent Application Publication
(10) Pub. No.: US 2016/0348626 A1
(43) Pub. Date: Dec. 1, 2016

(54) Automotive fuel pump

(71) Applicant: Advance Flow Engineering, Inc., Corona, CA (US)

(72) Inventor: Ken Zeller, Murrietta, CA (US)

(73) Assignee: Advance Flow Engineering, Inc.

(21) Appl. No.: 14/999,568

(22) Filed: May 26, 2016

Related U.S. Application Data
(60) Provisional application No. 62/230,121, filed on May 27, 2015.

(51) Int. Cl. F02M 59/12; F04C 15/00; F04C 15/06; F04C 2/08

(52) U.S. Cl. CPC F02M 59/12; F04C 2/084; F04C 15/008; F04C 15/06

(57) ABSTRACT

An automotive fuel pump is disclosed. There is a pump head that can operate in a passive mode and, when an electric motor powers spur gears, an active mode. The pump head can direct fuel to an air separator, then to a water trap, then to an air separator. After which the fuel is sent to the engine and any separated air and excess fuel is returned to the fuel tank.

### RELATED APPLICATIONS

This application claims priority under 35 U.S.C. §119 to U.S. Provisional Application No. 62/230,121 filed on May 27, 2015, the contents of which are incorporate herein by reference in their entirety.

### FIELD OF THE INVENTION

This invention is generally related to automotive fuel pumps. More particularly, the invention relates to a fuel pump that operates in response to increased engine demand and can employ an air separator, particulate filter, and water separator.

### BACKGROUND OF THE INVENTION

Automotive diesel engines rely upon a pump to transfer the diesel fuel from the fuel tank to the engine. During periods of peak demand on the engine, the pump must provide a higher consistent flow of fuel to meet the increased fuel needs of the engine. This is particularly true for turbocharged engines.

The turbocharger provides additional pressurized air (boost) to the engine and thus more fuel needs to be added. When the pump does not meet the fuel flow demand in response to increased air flow then engine performance and efficiency suffers.

What is needed is a system for providing fuel in response to increased engine demand.

### SUMMARY OF THE INVENTION

An embodiment of an automotive fuel pump for use with fuel under pressure has a pump head comprising a fuel inlet port in connection with an end of a first fuel path, and an opposing end of the first fuel path in connection with a first outlet port, a cavity for receiving spur gears and the cavity in connection with the inlet port and with the first end of the first fuel path and with a second fuel path, and the second fuel path in connection with a second output port. There are also spur gears disposed within the cavity and the spur gears having an inoperable state where fuel is primarily is directed down the first fuel path, and the spur gears having an operable state to primarily direct the flow of fuel into the second fuel path. Further, a bypass valve is disposed between the first fuel path opposing end and the fuel output port and the bypass valve is operable in an open state when fuel pressure is applied to the front of the bypass valve in the case of the spur gears in an inoperable state, and the bypass valve having a closed state when fuel pressure is substantially reduced in the case of the spur gears being in an operable state.

When fuel pressure is supplied to the inlet port and the spur gears are not operating, the fuel travels down the first fuel path thereby forcing the bypass valve open, allowing fuel to flow to the first outlet port, and when the spur gears arc operating, the spur gears push fuel through the cavity to the second outlet port and in so doing the fuel pressure force on the bypass valve is reduced and the bypass valve is in a closed state to substantially prevent fuel from flowing down the first outlet port.

### BRIEF DESCRIPTION OF THE DRAWINGS

The invention is generally shown by way of reference to the accompanying drawings in which:

FIG. 1 is a cross sectional perspective view of an embodiment of the pump head with the bypass valve in an open position;

FIG. 2 is a cross sectional perspective view of an embodiment of the pump head with the shuttle valve in a closed position;

FIG. 3 is a cross sectional perspective view of the pump head with another embodiment of the shuttle valve in the open position;

FIG. 4 is a cross sectional perspective view of the pump head with another embodiment of the shuttle valve in the closed position;

FIG. 5 is a view of an embodiment of the shuttle valve;

FIG. 6 is a perspective view of the pump, particulate filter, air separator, and water trap;

FIG. 7 is a cross-sectional view of the particulate filter, air separator, and water trap; and

FIG. 8 is a schematic depiction of a pressure sensor used to activate the electric motor.

### DETAILED DESCRIPTION OF THE INVENTION

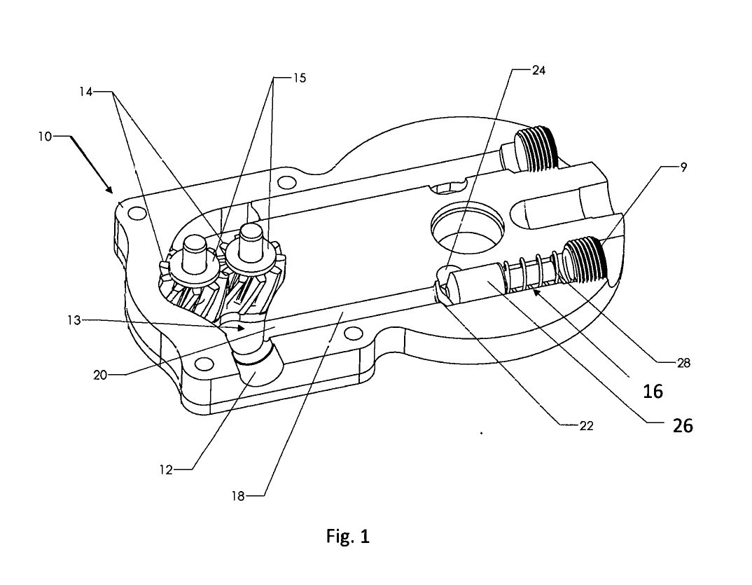

FIG. 1 is one embodiment of an automotive fuel pump for use with an internal combustion engine of the present invention. Embodiments of the invention can be used for diesel fuel engines and gasoline fuel engines. There is a pump head 10 and fuel enters the fuel pump through an inlet port 12.

One embodiment of the present invention utilizes a rotary type positive displacement gear pump. In this type of pump, the diesel fuel flow is achieved by two gears working together to push the fuel. One such embodiment employs helical spur gears 14. The gears are disposed in a cavity 13 that connects with the input port 12. The helical spur gears can be made of materials such as bronze, steel, nylon, or brass. Helical gears are chosen in this embodiment as the operation of the gears also generates less noise than straight cut gears. The gears can ride on bearings such as Polyether Ether Ketone (PEEK) 15 to reduce both surface noise and wear. When the spur gears 14 are rotating they are operable and when they are not turning they are inoperable.

During periods of normal demand by the engine, the spur gears 14 are not operating. In this instance the fuel pressure opens a bypass valve 16 and the fuel path bypasses the spur gears. This first fuel path 18 does not rely upon the operation of the electric motor or the spur gears. Naturally, some loss of fuel through the gears may occur, but such losses are not significant to the operation of the unit. The first fuel path 18 has opposing opening ends with one end 20 connecting to the input port 12 and the opposing end 22 connecting to the first outlet port 24. In the embodiment in FIG. 1, the opposing end 22 is formed to receive the head 26 of the bypass valve 16 in a substantially fluid tight manner.

When the spur gears 14 are not in operation, the fuel pressure forces the bypass valve 16 against the spring 28 which is held in place by the threaded plug 9 (The spring pressure can be varied by adjustment of the threaded plug 9 or by substitution of the spring 28). This opens a path leading from the input port 12 through the first path 18 to the output port 24 for the fuel to flow.

During peak demands a turbocharger increases the pressure of the air to the engine—boost. When boost of a predetermined level is detected then an electro-mechanical switch closes and sends power to the electric pump motor, which in turn rotates the spur gears.

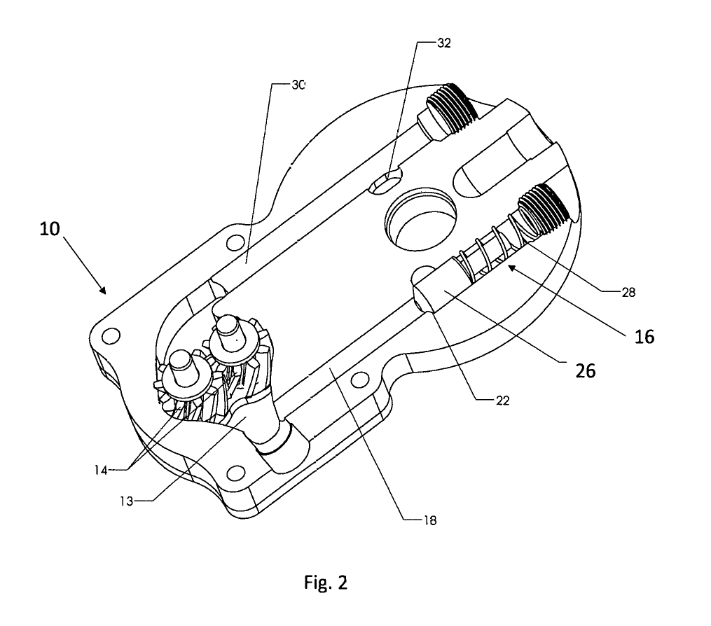

Turning to FIG. 2, the rotating spur gears 14 sends fuel down a second fuel path 30 to a second output port 32. The diversion of the fuel to this second fuel path 30 reduces the pressure in the first path 18 leading to the head 26 of the bypass valve 16 and the bypass valve 16 closes due to both increased fuel pressure on the back side of the bypass valve 16 and the spring 28. When the bypass valve 16 closes, the head 26 of the bypass valve 16 comes into contact with the opposing end of the first path 22. This forms a relatively liquid tight seal, thereby allowing only the second path for fuel flow to the engine.

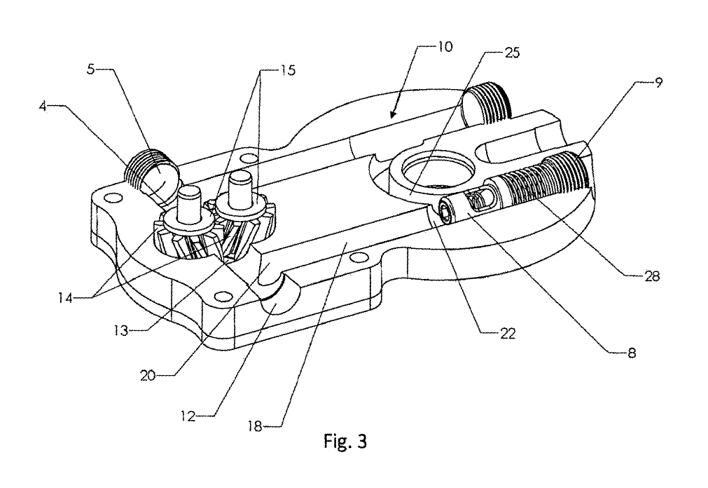

FIG. 3 is another embodiment of an automotive fuel pump for use with an internal combustion engine of the present invention. Embodiments of the invention can be used for diesel fuel engines and gasoline fuel engines. There is a pump head 10 and fuel enters the fuel pump through either inlet port 4 or inlet port 12 depending on which side the threaded plug 5 is located. This allows for multiple configurations depending on the application.

In the embodiment of FIG. 3, there is a rotary type positive displacement gear pump. In this type of pump, the diesel fuel flow is achieved by two gears working together to push the fuel. One such embodiment employs helical spur gears 14. The gears are disposed in a cavity 13 that connects with the input port 12. The helical spur gears can be made of materials such as bronze, steel, nylon, or brass. Helical gears are chosen in this embodiment as the operation of the gears also generates less noise than straight cut gears. The gears can ride on bearings such as Polyether Ether Ketone (PEEK) 15 to reduce both surface noise and wear.

During periods of normal demand by the engine, the spur gears 14 are not operating. In this instance the fuel pressure opens a shuttle valve 8 and the fuel path bypasses the spur gears as shown in FIG. 3. This first path 18 does not rely upon the operation of the electric motor or the spur gears. Naturally, some loss of fuel through the gears may occur, but such losses are not significant to the operation of the unit. The first path 18 has opposing opening ends with one end 20 connecting to the input port 12 and the opposing end 22 connecting to the outlet port 25.

When the spur gears 14 are not in operation, the fuel pressure forces the shuttle valve 8 against the spring 28 which is held in place by the threaded plug 9 (The spring pressure can be varied by adjustment of the threaded plug 9 or by substitution of the spring 28). This opens a path leading from the input port 12 through the first path 18 to the output port 25 for the fuel to flow.

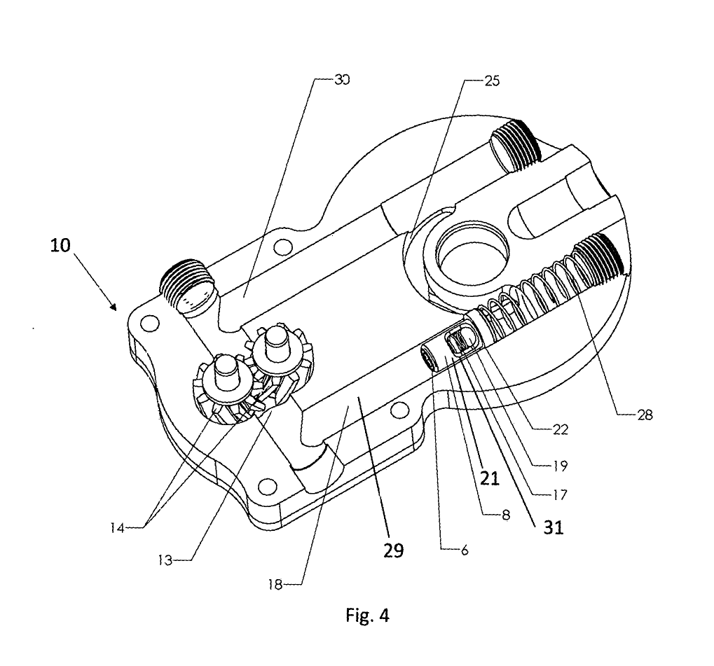

During peak demands a turbocharger increases the pressure of the air to the engine—boost. When boost of a predetermined level is detected then an electro-mechanical switch closes and sends power to the electric pump motor, which in turn rotates the spur gears. Turning to FIG. 4, the rotating spur gears 14 sends fuel down a second fuel path 30 to the output port 25 The diversion of the fuel to this second fuel path 30 reduces the pressure in the first path 18 leading to the shuttle valve 8, causing the shuttle valve 8 to close due to both increased fuel pressure on the back side of the shuttle valve 8 and the spring 28. When the shuttle valve 8 closes, the base of the shuttle valve 8 comes into contact with the opposing end of the first path 22. This forms a relatively liquid tight seal, thereby allowing only the second fuel path 30 for fuel flow to the engine.

As indicated in FIG. 4, a portion of the shuttle valve 8 fits within the first path 18. There is a space between the outer surface 21 of the shuttle valve 8 and the inner surface 29 of the first path 18 to allow fuel to flow. There is an opening 31 in the shuttle valve 8. A regulator spring 17 forces the regulator pintle 19 to seat within the shuttle valve 8 so that fuel does not flow between the first path 18 and the output port 25 when there is little to no fuel pressure in the outlet port 25.

When the fuel pressure in the outlet port 25 exceeds the load created by the regulator spring 17, the regulator pintle 19 is moved and fuel flows through a cavity in the shuttle valve 8 that forms a passageway between the output port 25 and the opening 31 and around the regulator pintle 19 thereby allowing fuel to pass through the opening 31 into the space between the outer surface 21 of the shuttle valve 8 and the inner surface 29 of the first path 18 and down the first path 18. The fuel then proceeds into the cavity 13 and recirculate back through the rotating spur gears 14. The regulator spring 17 pressure can be varied by adjustment of the threaded screw 6 or by substitution of the spring 17, creating different regulated pressures. In another embodiment of the invention, the shuttle valve 8 acts not only as a bypass valve but also as a fuel pressure regulator. In another embodiment of the invention, the threaded screw 6 may be hollow to allow additional fuel flow.

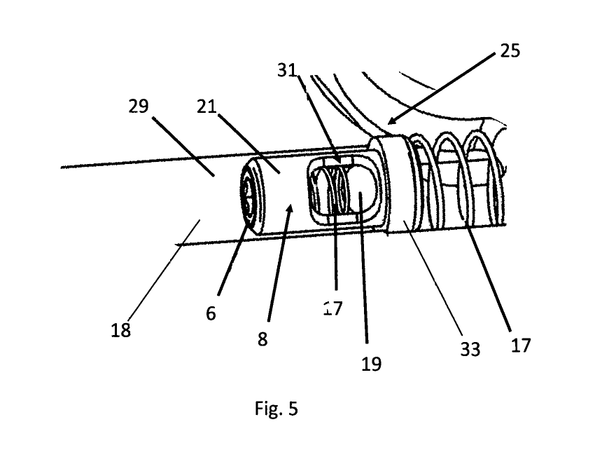

FIG. 5 is exploded view of the shuttle valve 8 in the closed position. Part of the shuttle valve 8 is in the first path 18 and the base 33 of the shuttle valve 8 forms a relatively liquid tight seal in the vicinity of the opposing end of the first path 22.

When a turbocharger is used, the boost increases the air available to the pistons for combustion with the diesel fuel. Automotive diesel fuel can include, for example, No. 2 Ultra Low Sulfur Diesel Fuel. This is a complex mixture of paraffins, cycloparaffins, olefins and aromatic hydrocarbon chains along with various contaminants. Depending upon operating conditions, the fuel may have particulate contaminants, water, and air that does not contribute to an efficient burn. To provide for a cleaner and more efficient burn, the fuel should be as free from contaminants as possible.

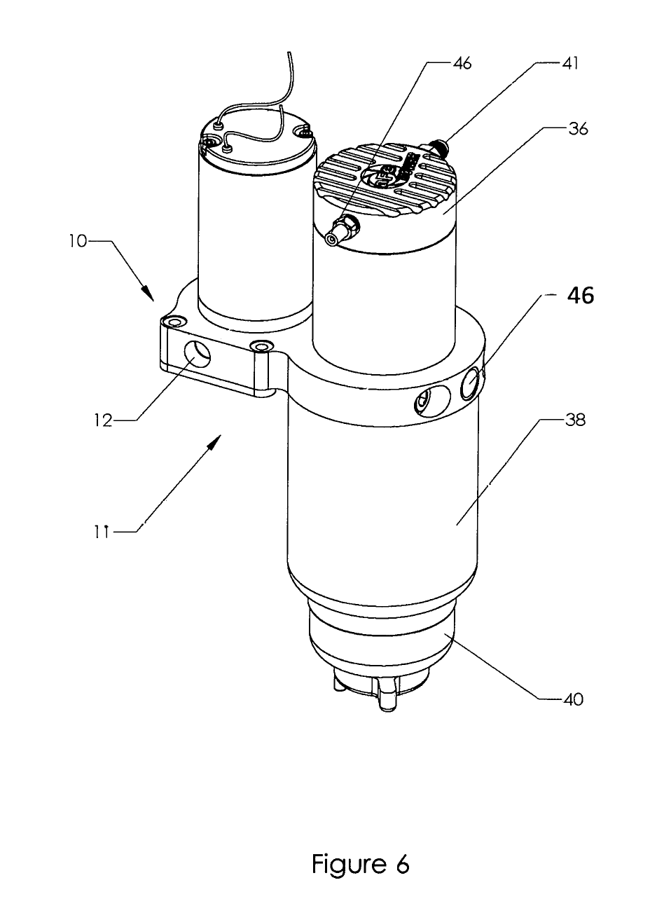

In FIG. 6, there is an electric motor 34 that drives the spur gears. In the embodiment identified, the pump head 10 is connected to an air separator 36, a particulate filter 38, and a water trap 40. In other embodiments, any combination could be used or just a single element. The particulate filter 38, air separator 36, and water trap 40 operate in conjunction to provide the engine a fuel that is cleaner than what would normally be found in the fuel tank. What results is the availability to the engine of a greater flow of cleaner fuel for combustion. The air separator sight glass 37 and water trap 40 in the present embodiment have clear materials incorporated to allow inspection of the fuel. The pressure valve 46 allows relief of pressure to aid in priming the fuel pump 11. The pressure valve 46 can allow be used to measure fuel pressure during operation. In another embodiment of the invention, the air separator sight glass 37 made be made from a different material such as aluminum.

In another embodiment of the invention, the speed of the electric motor 34 powering the gears could be made dependent upon the amount of boost. For example, if the boost were 20 psi then the motor would turn the gears to provide an amount of fuel that would be different than if the boost were 18 psi. The calibration could be accomplished as part of the production of the system or could allow the end user to perform their own calibration.

In another embodiment of the invention, the fuel pump 11 may be used as a full time diesel fuel pump. In this instance, the electric motor driving the gear pump would operate as a normal state when the engine would run. Again, the speed of the motor could be set at the factory or by an end user. Boost could still trigger an increased flow of fuel in a manner as already disclosed.

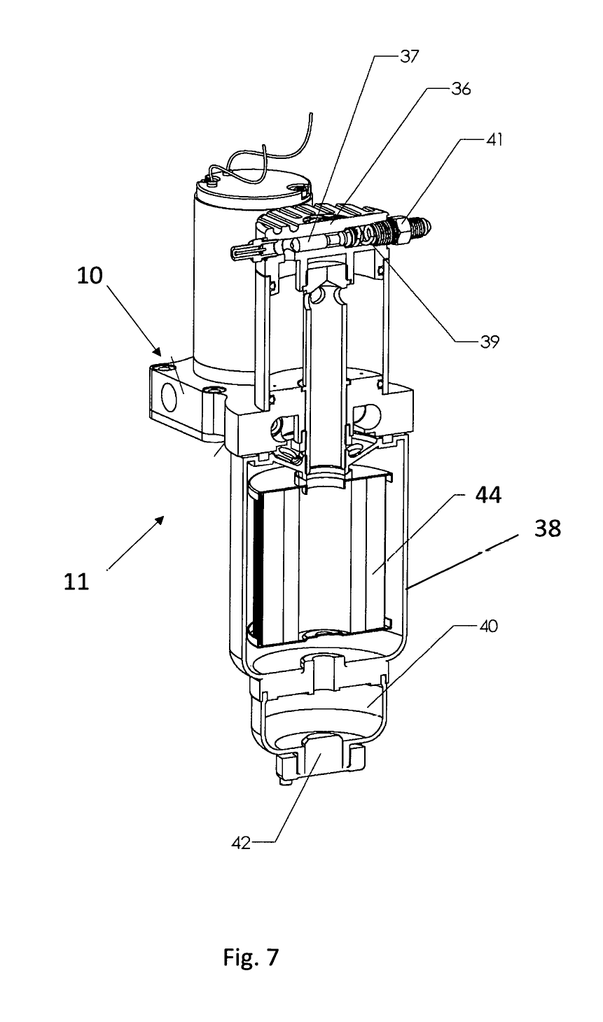

Turning to FIG. 7, whether or not the electric motor is operating the gears, the fuel flows from the pump head 10 into a chamber 38 that houses the particulate filter 44. The fuel comes into contact with the outside of the particulate filter 44 and filters through to the inside of the particulate filter. In another embodiment of the invention, the chamber 38 that houses the particulate filter 44 can he separated (such as with threads) to allow removal and replacement of the particulate filter 44.

The water falls to the bottom of the unit and accumulates in the water trap 40. The water can be released by use of the drain valve 42. The fuel is then sent into the air separator 36 where the air is removed from the fuel.

The fuel that passes through the particulate filter 44 is directed to the air separator 36.

In another embodiment of the invention, the air bypass piston 37 regulates air and fuel being returned to the fuel tank via the air bypass port 41. The air bypass piston 37 is acted upon by the air bypass piston spring 39 to control fuel and air flow and to keep the air bypass piston 37 in the closed position during certain conditions to create a vacuum within the fuel pump 11. The air bypass piston spring 39 pressure can be varied by adjustment of the threaded air bypass port 41 or by substitution of the air bypass piston spring 39, creating different regulated pressures.

Referring back to FIG. 6, after the fuel enters through port 12 and travels through the water trap 40, particulate filter 38, and air separator 36, it is sent out the final outlet 46 to the engine. Any separated air and excess fuel is sent out through the air bypass port 41 and returned to the fuel tank.

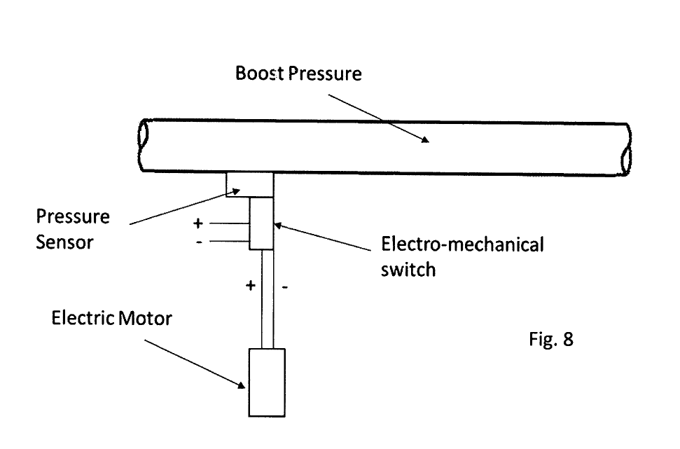

FIG. 8 identifies a boost pressure in the system as a result of a turbocharger. An elector-mechanical pressure sensor activates when the pressure reaches a specified amount. This results is sending power to the electric pump motor. When boost drops below the preset level, the switch opens and removes power from the electric pump motor. In another embodiment of the invention, the elector-mechanical pressure sensor is adjustable to allow different settings at different boost levels.

While embodiments have been described in detail, it should be appreciated that various modifications and/or variations may be made without departing from the scope or spirit of the invention. In this regard it is important to note that practicing the invention is not limited to the applications described herein above. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein above. Thus, it is intended that the invention cover all such embodiments and variations. Nothing in this disclosure is intended to limit the scope of the invention in any way.

What is claimed is:

1. An automotive fuel pump for use with fuel under pressure comprising;
a pump head comprising a fuel inlet port in connection with an end of a first fuel path, and an opposing end of the first fuel path in connection with a first outlet port, a cavity for receiving spur gears and the cavity in connection with the inlet port and with the first end of the first fuel path and with a second fuel path, and the second fuel path in connection with a second output port;
spur gears disposed within the cavity and the spur gears having an inoperable state where fuel is primarily directed down the first fuel path, and the spur gears having an operable state to primarily direct the flow of fuel into the second fuel path; and
a bypass valve disposed between the first fuel path opposing end and the fuel output port and the bypass valve operable in an open state when fuel pressure is applied to the front of the bypass valve in the case of the spur gears in an inoperable state, and the bypass valve having a closed state when fuel pressure is substantially reduced in the case of the spur gears being in an operable state;
wherein, when fuel pressure is supplied to the inlet port and the spur gears are not operating, the fuel travels down the first fuel path thereby forcing the bypass valve open, allowing fuel to flow to the first outlet port, and when the spur gears are operating, the spur gears push fuel through the cavity to the second outlet port and in so doing the fuel pressure force on the bypass valve is reduced and the bypass valve is in a closed state to substantially prevent fuel from flowing down the first outlet port.

2. The automotive fuel pump of claim 1 further comprising a particulate filter where the first outlet port and the second outlet port direct the fuel to the particulate filter.

3. The automotive fuel pump of claim 2 further comprising a water separator, where the fuel has a percentage of water and the water substantially separates out before entering the particulate filter and the water accumulates in a water trap.

4. The automotive fuel pump of claim 3 further comprising an air separator, where the fuel that passed through the particulate filter enters the air separator where air is separated from the fuel.

5. An automotive fuel pump for use with fuel under pressure comprising;
a pump head comprising a fuel inlet port in connection with an end of a first fuel path, and an opposing end of the first fuel path in connection with a first outlet port, a cavity for receiving spur gears and the cavity in connection with the inlet port and with the first end of the first fuel path and with a second fuel path, and the second fuel path in connection with a second output port;
spur gears disposed within the cavity and the spur gears having an inoperable state where fuel is primarily directed down the first fuel path, and the spur gears having an operable state to primarily direct the flow of fuel into the second fuel path; and
a shuttle valve disposed between the first fuel path opposing end and the fuel output port and the shuttle valve operable in an open state when fuel pressure is applied to the front of the shuttle valve in the case of the spur gears in an inoperable state, and the shuttle valve having a closed state when fuel pressure is substantially reduced in the case of the spur gears being in an operable state;
wherein, when fuel pressure is supplied to the inlet port and the spur gears are not operating, the fuel travels down the first fuel path thereby forcing the shuttle valve open, allowing fuel to flow to the first outlet port, and when the spur gears are operating, the spur gears push fuel through the cavity to the second outlet port and in so doing the fuel pressure force on the shuttle valve is reduced and the shuttle valve is in a closed state to substantially prevent fuel from flowing down the first outlet port.

6. The automotive fuel pump of claim 5, the shuttle valve further comprising a cavity that connects the first outlet port to the first fuel port, a regulator spring, a regulator pintle, and a threaded screw all within the cavity, and the threaded screw and regulator spring operate to apply force to the pintle in a closed position so that fuel does not travel between the first fuel port and the first outlet port and when pressure from the first outlet port is at a desired level, then the pintle operates in an open position that allows fuel to flow from the first outlet through the cavity and into the first fuel port;

7. The automotive fuel pump of claim 6, the shuttle valve further comprising an opening on the surface of the shuttle valve for fuel to flow through.

8. The automotive fuel pump of claim 6 further comprising a particulate filter where the first outlet port and the second outlet port direct the fuel to the particulate filter.

9. The automotive fuel pump of claim 8 further comprising a water separator, where the fuel has a percentage of water and the water substantially separates out before entering the particulate filter and the water accumulates in a water trap.

10. The automotive fuel pump of claim 9 further comprising an air separator, where the fuel that passed through the particulate filter enters the air separator where air is separated from the fuel.
